(19) United States
(12) Patent Application Publication
(10) Pub. No.: US 2024/0043255 A1
(43) Pub. Date: Feb. 8, 2024

(54) BREADING STATION

(71) Applicant: Duke Manufacturing Co., St. Louis, MO (US)

(72) Inventor: Michael McGaha, St. Louis, MO (US)

(21) Appl. No.: 18/364,801

(22) Filed: Aug. 3, 2023

Related U.S. Application Data
(60) Provisional application No. 63/370,328, filed on Aug. 3, 2022.

(51) Int. Cl. B66F 11/00; A23P 20/12

(52) U.S. Cl. CPC B66F 11/00; A23P 20/12

(57) ABSTRACT

A breading station for breading food has a housing including a well defining an ice bath compartment sized and shaped to receive an ice bath and one or more pans and a hydraulic lift system arranged to raise and lower the well relative to a surface on which the breading station rests on. The hydraulic lift system includes a hydraulic pump, a hydraulic linear actuator, and a hydraulic line fluidly connecting the hydraulic linear actuator to the hydraulic pump system. The hydraulic pump system and the hydraulic linear actuator are disconnectable and removable from the housing without having to break the fluid connection between the hydraulic pump system and the hydraulic linear actuator. An exterior panel blocks access to the hydraulic linear actuator and is removable to permit access to the hydraulic linear actuator. An adjustable pan frame can be used to organize the well to receive different pan sizes.

### CROSS-REFERENCE TO RELATED APPLICATION

The present application claims priority to U.S. Provisional Application No. 63/370,328, filed on Aug. 3, 2022, the entirety of which is incorporated herein by reference.

### FIELD

The present disclosure generally relates to a breading station for breading food to be cooked.

### BACKGROUND

Several different types of food product, such as fish (e.g., fish filets) and chicken (e.g., chicken breasts, chicken legs, chicken wings, chicken strips), are prepared to be cooked by breading the food product to coat the food product in a breading mixture. After the food product is breaded, the food product is cooked, such as by frying the food product. Typically, breading a food product includes dipping or coating the raw food product in a batter (which may contain eggs and milk) and then coating the food product with the breading. The batter adheres the breading to the food product. The breaded food product is then cooked by a cooking device, such as a fryer or oven.

### SUMMARY

In one aspect, a breading station comprises a housing including a well defining a cooling compartment sized and shaped to receive one or more pans. The cooling compartment has an opening sized and shaped to receive the one or more pans. A hydraulic lift system is arranged to raise and lower the well relative to a surface on which the breading station rests. The hydraulic lift system includes a hydraulic pump system and a hydraulic actuator. The hydraulic pump system is in fluid connection with the hydraulic actuator at in part via the hydraulic line so that operation of the hydraulic pump system actuates the hydraulic linear actuator to raise and lower the well. The hydraulic pump system and the hydraulic linear actuator are connected to the housing. The hydraulic pump system and the hydraulic linear actuator are disconnectable from the housing and removable from the housing without having to break the fluid connection between the hydraulic pump system and the hydraulic linear actuator.

In another aspect, a breading station comprises a housing including a well defining a cooling compartment sized and shaped to receive a one or more pans. The cooling compartment has an opening sized and shaped to receive the one or more pans. The housing includes a frame supporting the well and an exterior panel removably connected to the frame. A hydraulic lift system is arranged to raise and lower the well relative to a surface on which the breading station rests. The hydraulic lift system includes a hydraulic pump system and a hydraulic actuator having a fluid connection with the hydraulic pump system so that operation of the hydraulic pump system actuates the hydraulic actuator to raise and lower the well. The exterior panel is arranged to block access to the hydraulic actuator when the exterior panel is connected to the frame and is arranged to permit access to the hydraulic actuator when the exterior panel is disconnected from the frame.

In another aspect, a breading station comprises a housing including a well defining a cooling compartment sized and shaped to receive a plurality of pans. A pan frame is configured to be supported by the housing. The pan frame bounds a plurality of pan receiving areas for receiving the plurality of pans. The pan frame is arranged to suspend the plurality of pans in the cooling compartment when the pan frame is supported by the housing and the plurality of pans are received in the plurality of pan receiving areas. The pan frame is adjustable to change a dimension of at least one of the pan receiving areas to size said one pan receiving area for receiving different pan sizes.

In another aspect, a breading station comprises a housing including a well defining a cooling compartment sized and shaped to receive one or more pans. A cover includes a wall and first and second handles attached to the wall. The cover is arrangeable relative to the housing in a first position in which the cover is supported by the housing and the wall is upstanding, and a second position in which the cover is supported by the housing and the wall covers the ice bath compartment. The first and second handles are spaced apart from one another. The first and second handles are arranged to be grasped by one or more persons to move the cover between the first and second positions.

In another aspect, a breading station comprises a housing including a well defining a cooling compartment sized and shaped to receive one or more pans. A cover includes a wall and a mount attached to the wall. The cover is arrangeable relative to the housing in a first position in which the mount couples the cover to the housing and the wall is upstanding, and a second position in which the cover is supported by the housing and the wall covers the cooling compartment.

Other objects and features will be in part apparent and in part pointed out hereinafter.

### BRIEF DESCRIPTION OF THE DRAWINGS

FIG. 1 is a front perspective of a breading station according to one embodiment of the present disclosure;

FIG. 2 is a rear view of the breading station;

FIG. 3 is a cross section of the breading station;

FIG. 4 is a bottom view of a housing of the breading station, with a bottom exterior panel of the housing removed to show interior details;

FIG. 5 is a front perspective of the housing of the breading station, with exterior panels removed to show interior details;

FIG. 6 is a rear perspective of the housing of the breading station, with the exterior panels removed to show interior details;

FIG. 7 is an exploded view of the housing of the breading station with the exterior panels shown disconnected from a frame of the housing;

FIGS. 8A-C are perspective views illustrating the process for removing a linear actuator of a hydraulic lift system from the housing;

FIG. 9 is a perspective view of the housing;

FIG. 10 is an exploded view of the housing with a pan frame and a hold-down frame shown disconnected from the housing;

FIG. 11 is a perspective of the pan frame;

FIG. 12A is a top view of the housing of the breading station with the pan frame configured in a first orientation;

FIG. 12B is a top view of the housing of the breading station with the pan frame configured in a second orientation;

FIG. 13 is a perspective of a side shelf of the breading station;

FIG. 14 is a perspective of a cover of the breading station;

FIG. 15 is an enlarged perspective of the housing and the cover with the cover in an erect position; and

FIG. 16 is a perspective of the housing and the cover with the cover in a covering position.

Corresponding reference characters indicate corresponding parts throughout the drawings.

### DETAILED DESCRIPTION

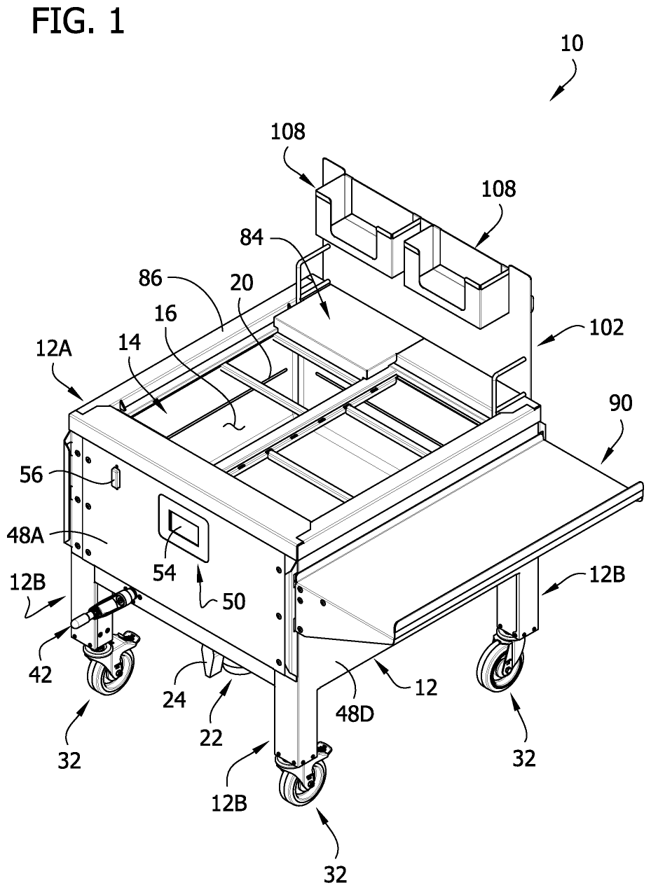

Referring to FIGS. 1-3, a breading station according to one embodiment of the present disclosure is indicated generally at reference numeral 10. The breading station 10 (broadly, food support apparatus) holds a plurality of (broadly, one or more) pans (e.g., food pans) for holding various ingredients (e.g., raw food, batter, breading, etc.) for performing a breading operation. By holding all the ingredients needed to bread a food product, the breading station 10 of the present disclosure enables an operator (e.g., a cook or chef) to quickly bread the food product. In one example, one pan may hold a raw food product, another pan may hold a batter or wash, and another pan may hold the breading (broadly, a food coater). This allows the operator to easily and quickly take one piece of food (e.g., a piece of row food, such as a raw fish fillet or a raw chicken breast), dip or dunk the piece of food in the batter, and then place the piece of food in the breading to coat the piece of food. After, the piece of food can then be moved to a cooking device, such as an oven or fryer, to be cooked. The breading station 10 is configurable to hold different sizes of pans (e.g., full size pan, ⅔ size pan, ½ size pan, ⅓ size pan) and is configurable to hold different numbers (e.g., 2, 3, 4, 5, 6, etc.) of pans. This allows the operator to arrange the pans (and therefore ingredients) as desired. To keep the ingredients at a safe holding temperature (e.g., at or below 40° F.), the breading station can refrigerate the pans. Although aspects of the present disclosure are described as associated with respect to a breading station, it will be appreciated that features disclosed herein can be used for other apparatus, such as food holding apparatus or food support apparatus.

The breading station 10 has a housing 12. The housing 12 includes a well 14 defining a cavity or compartment (e.g., an ice bath compartment) 16. The compartment 16 is sized and shaped to receive an ice bath (e.g., ice or a mixture of ice and water) for refrigerating the pans. It will be appreciated that instead of or in addition to the ice bath, a refrigeration system could be used. Moreover, in other embodiments, the compartment may be configured to hold food at ambient or heated conditions instead of cooled. The compartment 16 of the well 14 is also sized and shaped to receive the one or more (e.g., a plurality of) pans (not shown). The compartment 16 has a top opening. The top opening is sized and shaped to receive the one or more pans. The compartment 16 extends downward from an upper surface 86 of the housing 12. The well 14 includes four sidewalls and a bottom wall bounding the compartment 16. The sidewalls and bottom wall are desirably insulated, such as with polyurethane foam or the like, to assist in cooling the compartment. The operator can manually fill the compartment 16 with the ice bath by dumbing the ice bath into the compartment through the top opening. The interior (e.g. interior surface) of the well 14 may include a fill line 20, extending around some or all of the compartment 16, for indicating to the operator the desired level to fill the compartment with the ice bath. Instead of or in addition to the ice bath, a refrigeration system (e.g., compressor, evaporator, condenser) for refrigerating the pans can be used. However, such systems can be costly, may have greater operating expenses (e.g., electrical usage), may require more maintenance, and may be more expensive to repair than a breading station with an ice bath. The breading station 10 can include a drainage system 22 to drain fluid (e.g., water) from the compartment 16. The drain system 22 includes plumbing (e.g., pipe(s), fitting(s), valve(s), etc.) connected to a drain of the well 14. In the illustrated embodiment, the drainage system 22 includes a pipe extending down from the drain of the well 14, a valve 24, and a fitting downstream of the valve. The fitting can be used to couple to other plumbing, such as a hose, to direct the water away from the breading station. The valve 24 may be any suitable type of valve, such as a ball valve, and is desirably manually controlled. When needed, the operator can open the valve 24 to drain the ice bath (e.g., water) from the compartment 16. The valve 24 (e.g., actuator thereof) is disposed near the front of the breading station 10 for easy accessibility. Desirably, the valve 24 (e.g., actuator thereof) is disposed rearward of the front of the breading station 10 (e.g., rearward of the front exterior panel 48A of the housing 12) to lessen the risk of the user (e.g., the user's legs) accidently contacting the valve and inadvertently opening the valve.

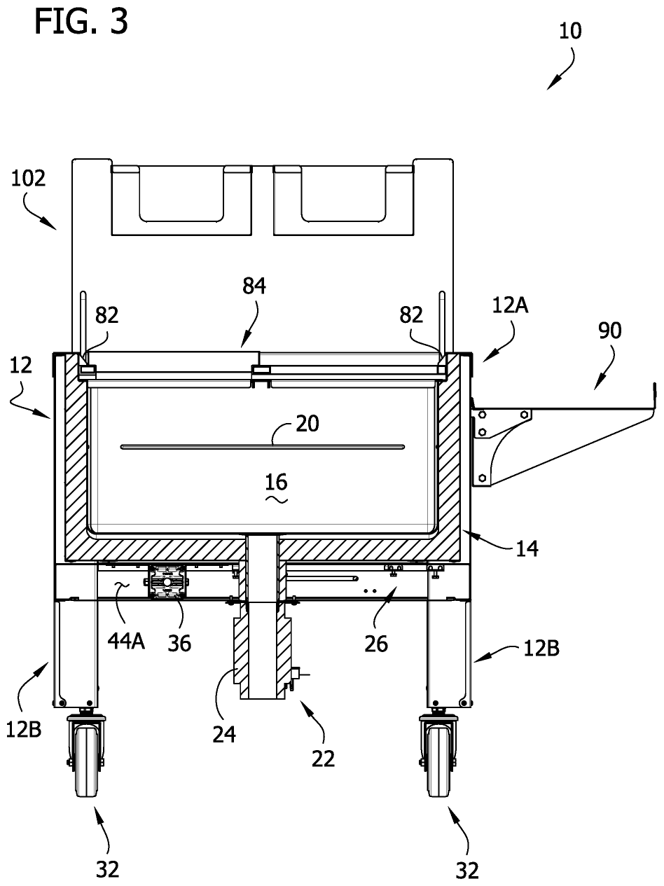

Referring to FIGS. 3-8C, the housing 12 includes a cabinet 12A containing the well 14 and a plurality (e.g., four) legs 12B extending downward from the cabinet. The housing includes a frame 26 supporting the well 14. The frame 26 forms part of the cabinet 12A and the legs 12B. In the illustrated embodiment, the frame 26 includes a base 28 and a plurality of leg frames 30 attached to the base. Each leg frame 30 extends in both the cabinet 12A and one of the legs 12B of the housing 12. The housing 12 includes a foot 32 at the bottom of each leg 12B. The feet 32 are arranged to engage a surface, such as a floor of a restaurant, to support the breading station 10 on the surface. In the illustrated embodiment, each foot 32 comprises a caster, although other types of feet, such as pads (e.g., rubber pads), are within the scope of the present disclosure. Each foot 32 may include a height adjustor (e.g., shims) for height adjustment to account for an uneven surface.

The breading station 10 includes a lift system 34 (e.g., a hydraulic lift system) arranged to raise and lower the well 14 (broadly, the housing 12) relative to the surface on which the breading station rests. This allows the operator to raise and lower the well 14 as desired, such as to better fit a height of a particular operator. In the illustrated embodiment, the lift system 34 is a hydraulic lift system, although other types of lift systems are within the scope of the present disclosure. The hydraulic lift system 34 includes a hydraulic pump system 36, a plurality of (broadly, one or more) hydraulic actuators (e.g. hydraulic linear actuators) 38, and a plurality of (broadly, one or more) hydraulic lines 40. Each hydraulic line 40 fluidly connects one of the linear actuators 38 to the pump system 36 so that operation of the pump system actuates the linear actuators to raise and lower the well 14. In one embodiment, the pump system 36 includes four individual pumps (not shown), one for each of the four linear actuators 38. The four individual pumps all move together so that the linear actuators 38 all move together and by the same amount. The four pumps may be housed in a common pump housing or mounted separately. The lift system 34 includes a pump actuator 42 to be operated by the operator to raise and lower the well 14. The illustrated pump actuator 42 comprises a hand crank or wheel operatively coupled to the pump system 36 by a drive drain. The operator manually turns the crank in one direction to raise the well 14 and manually turns the crank in the other direction to lower the well. The drive train may include a clutch to limit the amount of force a user can impart to the pump system 36 to prevent excessive pressure from building up in the lift system 34. For example, the clutch may slip, thereby preventing additional turns of the crank from operating the pump system 36, when the hydraulic pressure meets or exceeds 1000 lbs. The actuator 42 is disposed at the front of the breading station 10 for easy accessibility.

Each linear actuator 38 is at least partially disposed in one of the legs 12B. Each linear actuator 38 is operatively arranged between the foot 32 of the corresponding leg 12B and the well 14 such that operation of the pump system 36 actuates the linear actuator to change a distance between the foot and the well. Each foot 32 may be attached to a moveable piston (not shown) of the linear actuator 38. Operation of the pump system 36 moves the piston to extend or retract the foot 32.

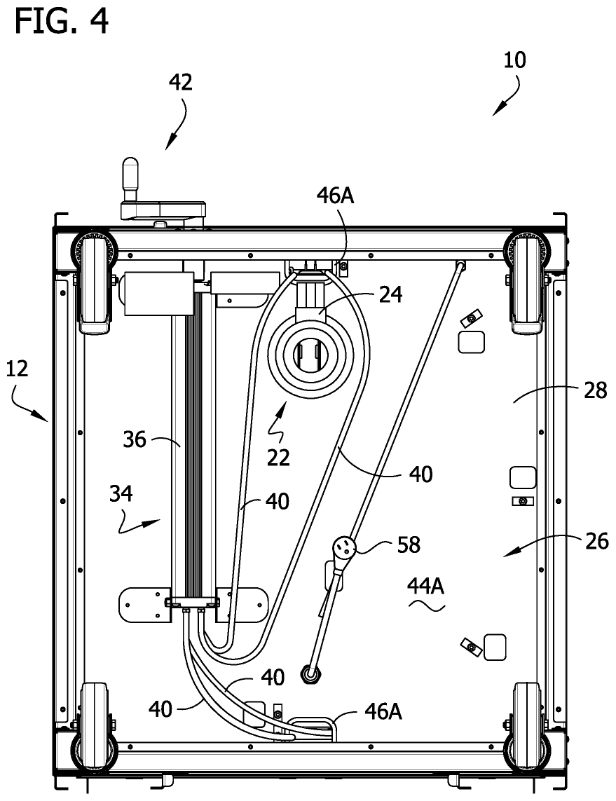

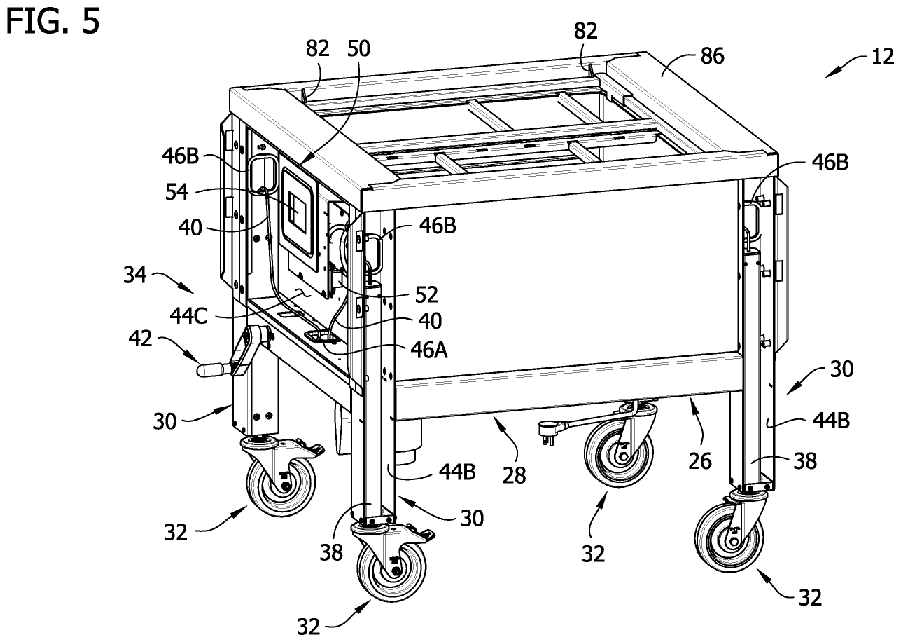

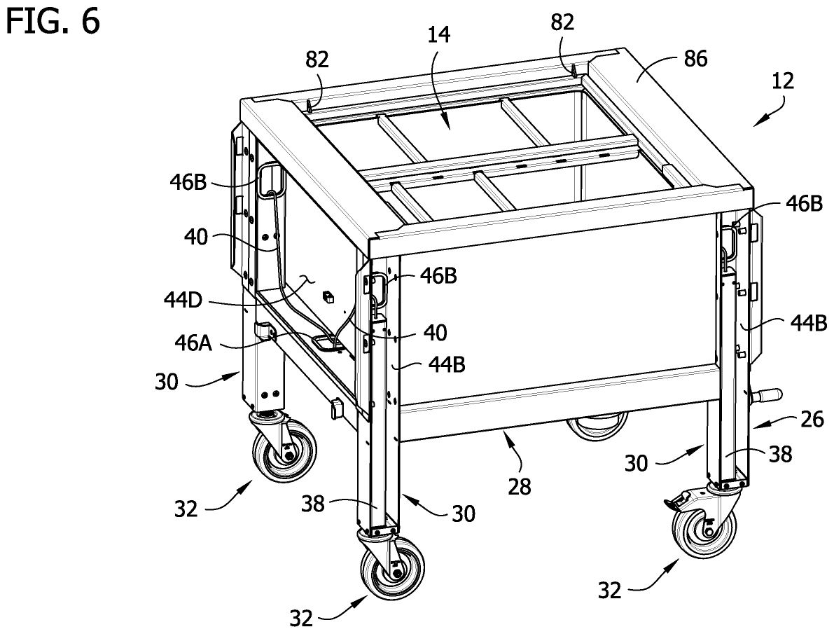

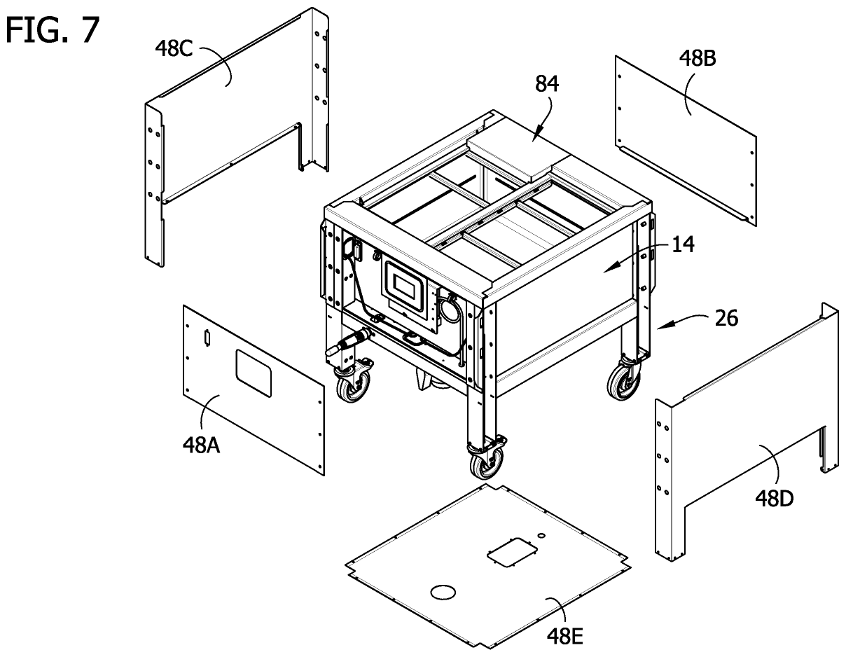

The housing 12 contains the various components (e.g., hydraulic pump, hydraulic lines, hydraulic linear actuators, etc.) of the breading station 10 and protects and shields these components. The frame 26 (broadly, the housing 12) defines a plurality of (broadly, one or more) interior cavities or chambers for containing the various components (e.g., hydraulic pump, hydraulic lines, hydraulic linear actuators, etc.) of the breading station 10. For example, the pump system 36 is disposed in a bottom cavity 44A (FIG. 4) defined by the base 28 of the frame 26 and each linear actuator 38 is disposed in a leg cavity 44B (FIGS. 5 and 6) defined by one of the leg frames 30 of the frame. The hydraulic lines 40 are flexible and extend within the interior cavities. The two hydraulic lines 40 connected to the linear actuators 38 in the two front legs 12B extend within the bottom cavity 44A, a front cavity 44C (FIG. 5) forward of the well 14, and within one of the respective leg cavities 44B. Similarly, the two hydraulic lines 40 connected to the linear actuators 38 in the two rear legs 12B extend within the bottom cavity 44A, a rear cavity 44D (FIG. 6) rearward of the well 14, and within one of the respective leg cavities 44B. The frame 26 includes a plurality of openings (e.g., hydraulic line openings) permitting the hydraulic lines 40 to travel within the housing 12 between the different interior cavities as the lines extend from the pump system 36 to the linear actuators 38. In the illustrated embodiment, the base 28 (e.g., an upper wall thereof) includes two openings 46A, one adjacent the forward side of the base and the other adjacent a rearward side of the base. The two hydraulic lines 40 connected to the linear actuators 38 in the two front legs 12B extend through the forward opening 46A as these lines go from the bottom cavity 44A to the front cavity 44C. The two hydraulic lines 40 connected to the linear actuators 38 in the two rear legs 12B extend through the rearward opening 46A as these lines go from the bottom cavity 44A to the rear cavity 44D. In addition, each leg frame 30 (e.g., a sidewall thereof) includes an opening 46B, adjacent the upper end of the leg frame. The hydraulic line 40 for each respective leg 12B extends through the opening 46B of the leg frame 30 as the line goes from the front or rear cavity 44C, 44D to the leg cavity 44B to reach the linear actuator 38. Other arrangements and configurations of the openings and other ways of routing the hydraulic lines through the housing are within the scope of the present disclosure.

The housing 12 includes a plurality (broadly, one or more) removable exterior panels for accessing the various components contained within the housing 12. In the illustrated embodiment, the housing 12 includes a front exterior panel 48A, a rear exterior panel 48B, a left side exterior panel 48C, a right side exterior panel 48D, and a bottom or lower exterior panel 48E. The exterior panels 48A-E are removably connected to the frame 26, such as by one or more threaded fasteners (e.g., bolts or screws). This allows the exterior panels 48A-E to be easily removed to access the various components contained within the housing 12. The front exterior panel 48A is disposed on (e.g., defines) the front of the housing 12 and bounds (e.g., encloses) the front cavity 44C. The front exterior panel 48A blocks access to the front cavity 44C, and components therein. For example, the front exterior panel 48A is arranged to block access to the openings 46A, 46B in communication with the front cavity 44C and the hydraulic lines 40 in the front cavity when the front panel is connected to the frame 26 and permits access to these components when disconnected from the frame. The rear exterior panel 48B is disposed on (e.g., defines) the rear of the housing 12 and bounds (e.g., encloses) the rear cavity 44D. The rear exterior panel 48B blocks access to the rear cavity 44D, and components therein. For example, the rear exterior panel 48B is arranged to block access to the openings 46A, 46B in communication with the rear cavity 44D and the hydraulic lines 40 in the rear cavity when the rear panel is connected to the frame 26 and permits access to these components when disconnected from the frame. The left side exterior panel 48C is disposed on (e.g., defines) the left side of the housing 12 and bounds (e.g., encloses) the two leg cavities 44B on the left side of the housing (e.g., front left leg cavity and rear left leg cavity). The left side exterior panel 48C blocks access to these two leg cavities 44B, and components therein. For example, the left side exterior panel 48C is arranged to block access to the openings 46B in communication with these two leg cavities 44B, the linear actuators 38 in these leg cavities, and the hydraulic lines 40 in these leg cavities when the left side panel is connected to the frame 26 and permits access to these components when disconnected from the frame. The left side exterior panel 48C forms a portion (broadly, at least a portion) of the two legs 12B on the left side of the housing 12. The right side exterior panel 48D is disposed on (e.g., defines) the right side of the housing 12 and bounds (e.g., encloses) the two leg cavities 44B on the right side of the housing (e.g., front right leg cavity and rear right leg cavity). The right side exterior panel 48D blocks access to these two leg cavities 44B, and components therein. For example, the right side exterior panel 48D is arranged to block access to the openings 46B in communication with these two leg cavities 44B, the linear actuators 38 in these leg cavities, and the hydraulic lines 40 in these leg cavities when the right side panel is connected to the frame 26 and permits access to these components when disconnected from the frame. The right side exterior panel 48D forms a portion (broadly, at least a portion) of the two legs 12B on the right side of the housing 12. Likewise, the lower exterior panel 48E is disposed on (e.g., defines) a bottom of the cabinet 12A and bounds (e.g., encloses) the bottom cavity 44A. The lower exterior panel 48E blocks access to the bottom cavity 44A, and components therein. For example, the lower exterior panel 48E is arranged to block access to the openings 46A in communication with the bottom cavity 44A, the pump system 36, and the hydraulic lines 40 in the bottom cavity when the lower panel is connected to the frame 26 and permits access to these components when disconnected from the frame.

The exterior panels 48A-E may include one or more gaskets positioned around the periphery of the panel and arranged to engage the frame 26 (or other portion of the housing 12) to form a seal therebetween that prevents the ingress of debris into the interior of the housing. The one or more gaskets may extend around a majority of the periphery, nearly all the periphery, or the entire periphery of the panel.

Still referring to FIGS. 3-8C, the lift system 34 is connected to and supported by the housing 12. Specifically, the pump system 36 and the linear actuators 38 are connected to and supported by the frame 26 of the housing 12. The lift system 34 (e.g., the pump system 36, the linear actuators 38, and the hydraulic lines 40) is disconnectable from the housing and removable from the housing. The pump system 36 and the linear actuators 38 are each, desirably, attached to the frame 26 with one or more fasteners (e.g., threaded fasteners), which allows the pump system 36 and the linear actuators 38 to be easily disconnected from the frame. The hydraulic lines 40 may be attached to the frame 26 with one or more clips or may loosely extend through the housing 12. Other ways of attaching the components of the lift system to the housing are within the scope of the present disclosure.

The lift system 34 (e.g., the pump system 36, the linear actuators 38, and the hydraulic lines 40) is also removable from the housing 12 (e.g., completely separable from the housing such that the lift system 34 can move fully independently of the housing) without having to break the fluid connection between the pump system and the linear actuators. Similarly, the lift system 34 (e.g., the pump system 36, the linear actuators 38, and the hydraulic lines 40) is also installable in the housing 12 (e.g., can be arranged in and connected to the housing) with existing fluid connections between the pump system and the linear actuators and without having to break any of those existing fluid connection. This allows the lift system 34 to be assembled prior to being positioned in and connected to the housing 12. It is easier to fill the lift system 34 with hydraulic fluid before the lift system 34 is installed in the housing 12. Similarly, this makes it easier to remove the lift system 34, such as to perform maintenance or replace a component of the lift system, by not having to break any fluid connections. A break in a fluid connection (such as disconnecting a linear actuator 38 from a hydraulic line 40 or cutting a hydraulic line) could result in hydraulic fluid leaking out of the lift system 34 that would need to be collected and/or cleaned up and may result in discoordination of components of the hydraulic system (e.g., hydraulic actuators out of sync). To enable the lift system 34 to be installed in and removed from the housing 12 while maintaining the fluid connections between the pump system 36, the linear actuators 38, and the hydraulic lines 40, the openings 44A, 46B are each sized and shaped to enable the linear actuator 38 to pass therethrough (e.g., pass therethrough one at a time) to permit the linear actuators to be arranged in and/or removed from the housing. In general, the housing 12 (specifically, the frame 26) has the necessary sized and positioned openings (e.g., notches, gaps, slots, apertures, etc.), and/or spaces/cavities (accessible when the exterior panels are removed) necessary to permit the linear actuators 38 and hydraulic lines to be moved therethrough so that the linear actuators can be positioned in the legs 12B and the hydraulic lines 40 routed within the housing even though they are connected to the pump system 36.

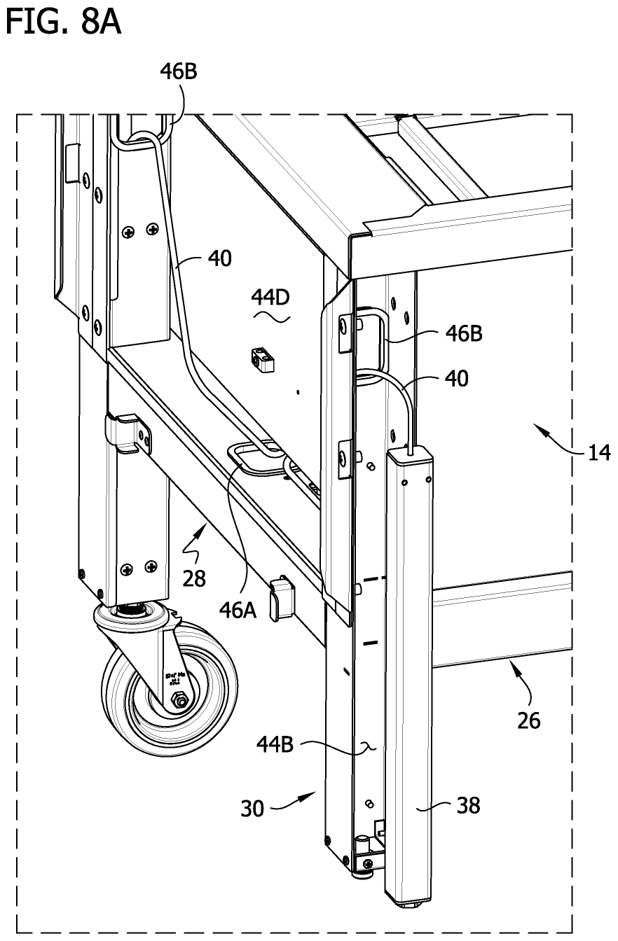

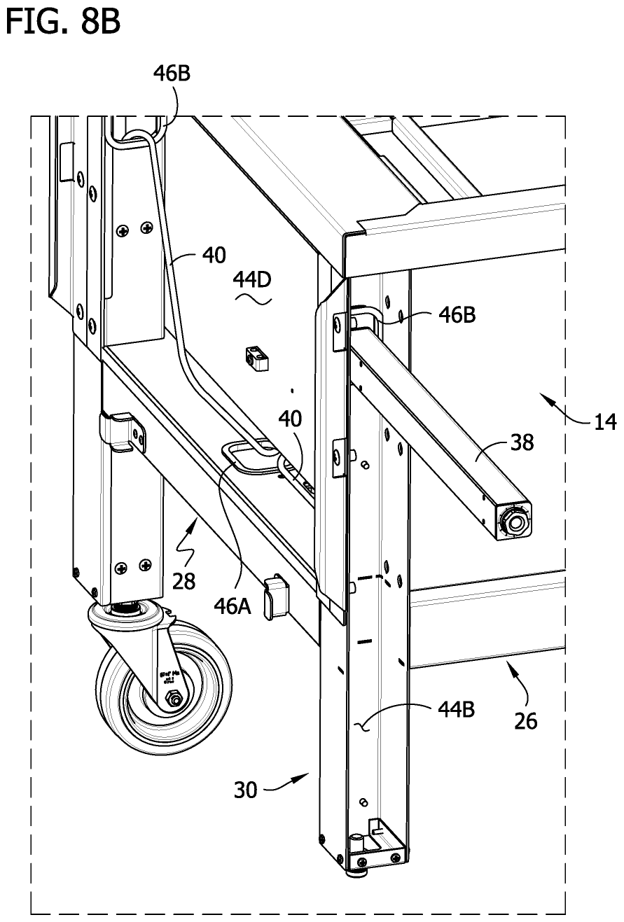

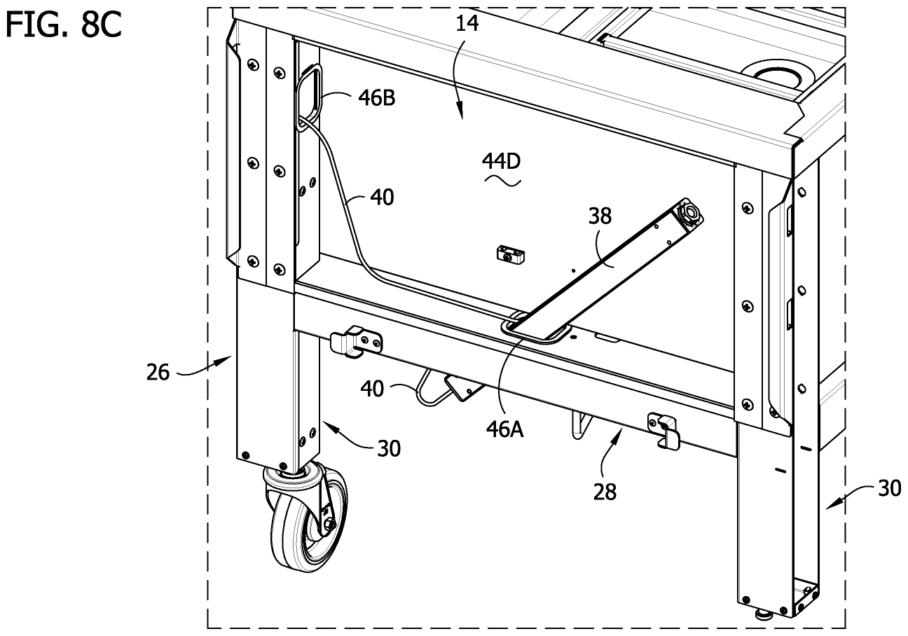

For example, referring to FIGS. 8A-C, to remove the lift system 34 from the housing 12, first the exterior panels 48A-E are disconnected and removed from the frame 26 to access the components of the lift system. The feet 32 are also disconnected from the linear actuators 38. After, one linear actuators 38 is disconnected from the leg frames 30 (via the one or more threaded fasteners) as shown in FIG. 8A. Next, said one linear actuator 38 is inserted (e.g., threaded) through the opening 46B in the leg frame 30 as shown in FIG. 8B. Then, said one linear actuator is inserted through the opening 46A in the base 28 as shown in FIG. 8C. This process is repeated for each of the linear actuators 38. After this is completed, the pump system 36 can be disconnected from the base 26 (via the one or more threaded fasteners) and disconnected from the drive train. The pump system 36, the linear actuators 38, and the hydraulic lines 40 can now be removed from (e.g., carried away from) the housing 12, such as to perform maintenance and/or replace a part. These steps are generally performed in reverse to install the lift system 34 in the housing 12. To install the lift system 34, first the pump system 36 may be connected to the base 12. The pump system may be connected to the drive train now or later. Then, each linear actuator 38 is positioned in one of the legs 12B (e.g., leg frames 30). To do this, one linear actuator 38 is inserted upward through the opening 46A in the base 12 and then inserted through the opening 46B in the leg frame 30. After said one linear actuator 38 is connected to the leg frame 30. This process is repeated for each of the linear actuators 38. After, the feet 32 are connected to the linear actuators 38. With the lift system 34 now installed, the exterior panels 48A-E can be connected to the frame 26.

Referring back to FIGS. 1 and 5, the breading station 10 may include a control system 50. The control system 50 can include a controller 52, user interface 54, a wireless transceiver 56, and one or more (e.g., two) temperature sensors (not shown) arranged to detect the temperature within the compartment 16. The temperature sensor(s) may be embedded in the well 14. The user interface 54, the wireless transceiver 56, and temperature sensors are electrically connected to the controller. A power source 58 (FIG. 4), such as an electrical plug for a wall outlet, provides power for the control system 50. The user interface 54 may comprise a touch screen display that can display the temperature sensed by temperature sensor. The display of the user interface 54, or a portion thereof, may change colors based on the displayed temperature. For example, the display may be predominately of a green color when the temperature is at or below 40° F. (indicating the temperature of the compartment 16 is suitable for holding and maintaining the food), a yellow color when the temperature is between 40° F.-50° F. (indicating the compartment is warming and needs to refilled with ice), and/or a red color when the temperature is above 50° F. (indicating the compartment is no longer suitable for holding food at a safe temperature). A clear cover, such as a glass (e.g., gorilla glass) cover may be included to cover and protect the display. The control system 50 may also include an audible alarm (not shown) configured to generate a noise to alert the user when the temperature in the compartment 16 is too warm. For example, the audible alarm may make a first noise when the temperature is between 40° F.-50° F. and a second noise (different from the first noise) when the temperature is above 50° F. The control system 50 may also transmit temperature data indicative of the temperature of the compartment 16 to other systems, such as restaurant management systems, via the wireless transceiver 56. Other configurations of the control system 50 are within the scope of the present disclosure.

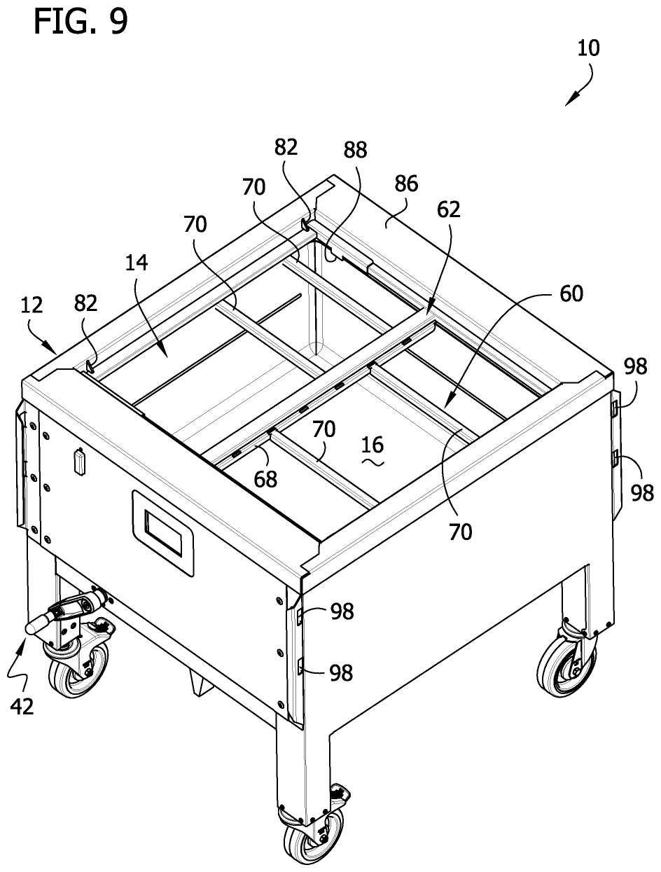

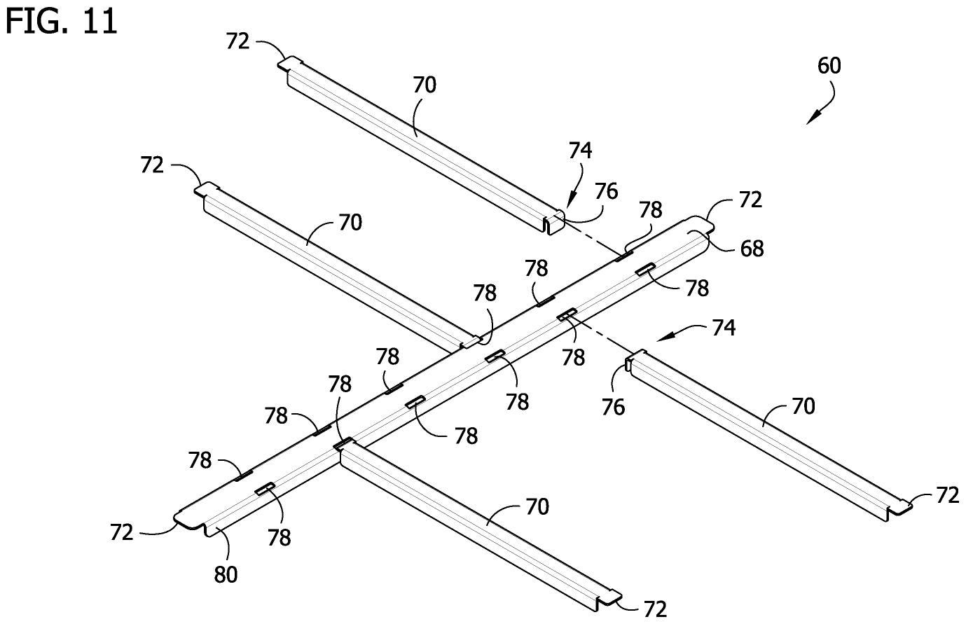

Referring to FIGS. 9-12B, the breading station 10 includes a pan organization and retention system for suspending, arranging, and holding the pans in the compartment 16. The pan organization and retention system includes a pan frame or organizer 60 and a hold-down frame or pan retainer 62. The pan frame 60 is removably supported by the housing 12, specifically the well 14. The well 14 includes a lip or shoulder 64 extending around the perimeter of the compartment 16 adjacent the top of the well. The lip 64 supports the pan frame 60, the pans, and the hold-down frame 62. The pan frame 60 rests on the lip 64. The pan frame 60 is configured to position the pans in the compartment 16. The pan frame 60 bounds (e.g., forms) a plurality of pan areas or receiving spaces 66A-E sized and shaped to receive the plurality of pans. Each pan area 66A-E is sized and shaped to receive a specific size of pan (e.g., a full size pan, a ⅔ size pan, a ½ size pan, a ⅓ size pan). In the illustrated embodiment, the pan frame 60 is arranged to bound five pan areas 66A-E, however the pan frame is configurable (described in more detail below) such that the pan frame can define any number (e.g., 1, 2, 3, 4, 5, 6, etc.) of pan areas. The exact number of pan areas the pan frame can form will depend on the size (e.g., length and/or width) of the compartment 16. The pan areas are subsections of the compartment 16. The pan frame 60 suspends the pans in the compartment 16. When positioning the pans in the compartment 16, the pans are inserted down through the pan areas 66A-E. The lips or rims of the pans rest on the pan frame 60 (and the lip 64 of the well 14) to suspend the pans in the compartment 16.

The pan frame 60 is configurable for generating different pan layouts (e.g., different numbers, arrangements, and/or sizes of pans). The pan frame 60 is adjustable or reconfigurable to form different numbers of, arrangements of, and/or sizes of the pan areas for the breading station 10. In particular, the pan frame 60 is adjustable to change a dimension D of at least one pan area (e.g., all of the pan areas 66A-E) to size and shape the at least one pan area for different size pans. In the illustrated embodiment, all the illustrated pan areas 66A-E are adjustable in size. The pan frame 60 includes a first or main support or strut 68 and a plurality of (broadly, none or at least one) secondary supports or struts 70. The illustrated embodiment includes four secondary supports 70, although more or fewer (e.g., none, 1, 2, 3, 5, 6, 7, 8, etc.) secondary supports can be used. Together the first support 68 and the secondary supports 70 bound the pan areas 66A-E. The first support 68 is configured to extend front to back across the compartment 16 and bounds inner sides of the pan areas 66A-E. The first support 68 includes two tabs or flanges 72 at the opposite ends of the first support. The tabs 72 are arranged to rest on the lip 64 of the well 14 to support the pan frame 60 (and thereby the pans) in the compartment 16. The secondary supports 70 extend from the first support 68 to one of the sides (e.g., left or right side) of the well 14. Each secondary support 70 also includes a tab or flange 72 at its outer end. The tab 72 of each secondary support 70 is arranged to rest on the lip 64 of the well 14 to support the pan frame 60 (and thereby the pans) in the compartment 16. Each secondary support 70 bounds one or two pan areas 66A-E. The second supports 70 are selectively and removably positionable on the first support 68 to configure the pan frame 60 for different numbers, arrangements, and/or sizes of pans. The second supports 70 are movable relative to (e.g., along the length of) the first support 68 to change a dimension D (e.g., a width measured front to back) of the pan areas 66A-E. Moving one second support 70 changes the dimension of one, and maybe two, pan areas 66A-E, thereby reconfiguring said one or two pan areas for different sizes of pans.

The first support 68 has a plurality (e.g., first, second, third, fourth, etc.) of locations (e.g., connection locations) spaced apart along its length. Each secondary support 70 is removably connectable to the first support 68 at the plurality of locations. In the illustrated embodiment, the connection locations are uniformly spaced apart along the first support 68 at an interval (e.g., an on center interval) corresponding to half the width of a ⅓ size pan. Half the width of a ⅓ size pan is approximately 3.44″ (e.g., 4 7/16″). This allows the secondary supports 70 to be connected to the first support 68 in a manner that allows the pan areas to be sized based on multiple of ⅙ (e.g., two intervals (2×⅙) are used to create a ⅓ size pan area, three intervals (3×⅙) are used to create a ½ size pan area, four intervals (4×⅙) are used to create a ⅔ size pan area, and six intervals (6×⅙) are used to create a full size pan area), thereby allowing the pan frame 60 be configured to support a variety of full size pans, ⅔ size pans, ½ size pans, and/or ⅓ size pans. Desirably, each secondary support 70 is connectable and disconnectable from the first support 68 without the use of tools. In the illustrated embodiment, each secondary support 70 includes a connector 74 for connecting the secondary support to the first support. The connector 74 is desirably a manually operable connector, and even more desirably, can be manually operated without the use of tools. In the illustrated embodiment, the connector 74 comprises a hook 76. The hook 76 is formed by an L-shaped flange at the end of the secondary support 70 opposite the tab 72. Each connector 74 connects to the first support 68 at one of the connection locations. In the illustrated embodiment, each connection location is defined by an opening or cavity 78 of the first support 68. Each opening 78 is sized and shaped to receive the hook 76 of the connector 74. The first support 68 may also include a sidewall 80 extending downward from the opening 78. The hook 76 may extend along and engage the sidewall 80. Further, the end of a body of the secondary support may face and be spaced apart from the hook, thereby defining a space to receive the sidewall 80. The results in the secondary support 70 engaging the opposite faces of the sidewall 80 to stabilize the connection between secondary support and the first support 68 (e.g., prevent the secondary support from twisting and/or racking relative to the first support). The first support 68 includes one sidewall 80 extending along the openings 78 on one side of the support and another sidewall extending along the openings on the other side of the support. Other ways of connecting the secondary supports to the first support are within the scope of the present disclosure.

The first support 68 and the secondary supports 70 each include upper surfaces that are generally coplanar with one another when the secondary supports are connected to the first supports. The lips of the pans rest on the upper surfaces of the first and secondary supports 68, 70 to suspend the pans in the compartment 16. Accordingly, together the lip 64 of the well 14 and the upper surfaces of the first and secondary supports 68, 70 support the pans in the compartment 16.

The pan frame 60 is configured to form pan areas 66A-E such that each pan area is sized and shaped to receive a single full size pan, a single ⅔ size pan, a single ½ size pan, and a single ⅓ size pan. These are the more common pan sizes used in the restaurant industry, and are particularly suitable for the breading station 10 (e.g., food preparation and holding) because they are among the larger sizes of pans. While these are the sizes of the pan areas 66A-E that can be formed, it is understood that one pan area may receive two or more pans of smaller sizes than what the size of the pan area is sized for. For example, a full size pan area may receive one ⅔ size pan and ⅓ size pan, or two ½ size pans, or three ⅓ size pans, or other combinations of other sizes (e.g., smaller sizes such as ¼ size, ⅙ size, ⅛ size, 1/9 size, etc.) of pans. A full size full size pan measures about 20.75″×12.75″, a ⅔ size pan measures about 13.75″×12.75″, a ½ size pan measures about 12.75″×10.375″, and a ⅓ size pan measures about 12.75″×6.875″. Thus, each of these pan sizes (e.g., full, ⅔, ½, and ⅓) shares a common dimension of about 12.75″ (smaller sizes of pans do not have this dimension). The pan frame 60 (e.g., the second supports 70) is configured to be used to define pan areas 66A-E corresponding to this dimension. The second supports 70 have a length corresponding to the 12.75″ pan dimension, thereby spacing the first support 68 relative to the left and right sides of the well 14 to receive pans having this 12.75″ dimension. Accordingly, the pan frame 60 of the present disclosure can only define full size pan areas, ⅔ size pan areas, ½ size pan areas, and ⅓ size pan areas. Again, while these are the only sizes of pan areas that can be formed, smaller sizes of pans can still be used. For example, three 1/9 size pans can fit within a ⅓ size pan area. Further, it is understood the pan frame may include one or more additional first supports 68 and one or more additional secondary supports 70 of other lengths so that the pan frame can be configured to form smaller sizes of pan areas.

In the illustrated embodiment, the pan frame 60 (and the well 14) is arranged to form two rows of pan areas, which each row having a front to back length sufficient to hold one ⅔ size pan and one ½ size pan at the same time. With these dimensions of the pan frame 60 and the well 14, and the locations of the connection locations (e.g., openings 78) on the first support 68 for the secondary supports 70, the pan frame 60 can be arranged to form a large amount of different pan area 66A-E size combinations, which are summarized in Table 1 below. In Table 1, the first column on the left indicates the total number of pan areas a given configuration of the pan frame 60 will form (e.g. the total number of pans that can be held in a given configuration (assuming each pan area receives one pan)). The remaining columns include the number of the different size pan areas the given configuration can have (e.g., the number of each size of pan that can be held). If a cell is left blank, that means 0.

TABLE 1

| | Number of Each Pan Area Size (e.g., Pan Size) | | | |
|---|---|---|---|---|
| Number of Pan | For a Given Configuration | | | |
| Areas (e.g., Pans) | Full | ⅔ | ½ | ⅓ |
| For a Given | Size Area | Size Area | Size Area | Size Area |
| Configuration | (e.g., Pan) | (e.g., Pan | (e.g., Pan) | (e.g., Pan) |
| 2 | 2 | | | |
| 3 | 1 | 1 | 1 | |
| 3 | 1 | | 2 | |
| 4 | 1 | | | 3 |
| 4 | 1 | | 1 | 2 |
| 4 | | | 4 | |
| 4 | | 2 | 2 | |
| 4 | | 2 | | 2 |
| 5 | | 1 | 2 | 2 |
| 5 | | 1 | 1 | 3 |
| 5 | | | 2 | 3 |
| 5 | | 1 | | 4 |
| 6 | | | | 6 |
| 6 | | | 2 | 4 |

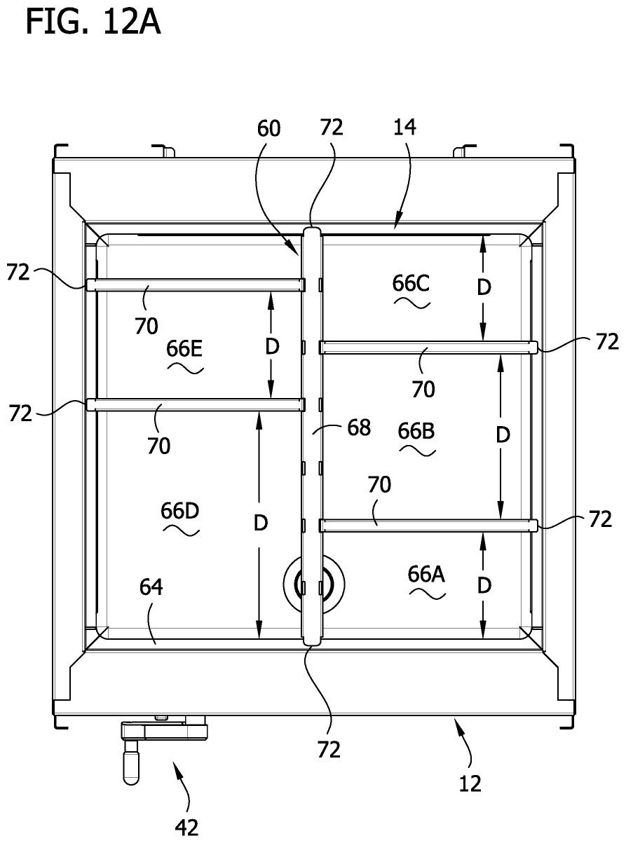

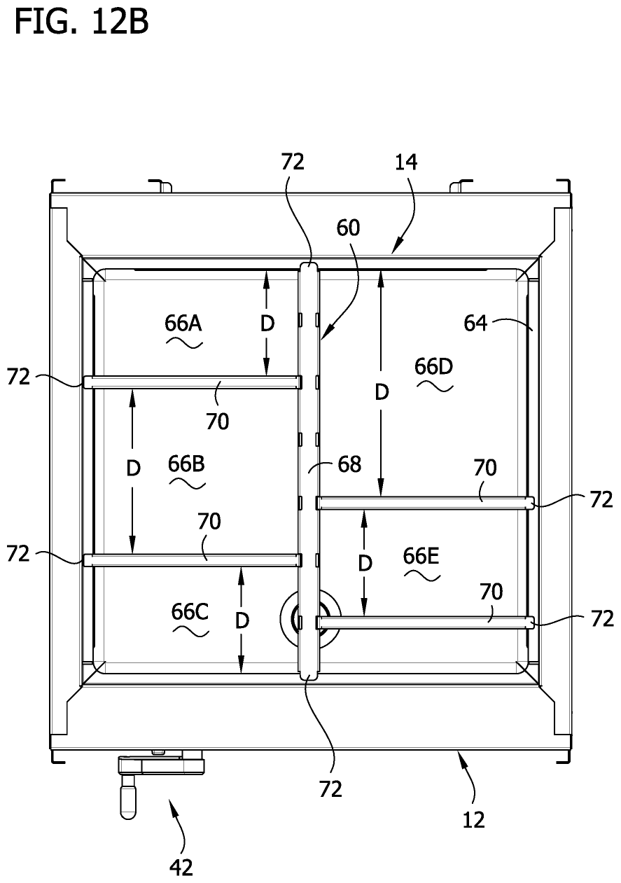

In view of Table 1 above, the pan frame 60 of the present disclosure can be configured or arranged in one (e.g., a first) configuration where the pan frame bounds only two pan areas, another (e.g., second) configuration where the pan frame bounds only three pan areas, another (e.g., third) configuration where the pan frame bounds only four pan areas, another (e.g., fourth) configuration where the pan frame bounds only five pan areas, and another (e.g., fifth) configuration where the pan frame bounds only six pan areas. The five pan area configuration of the pan frame 60 with one ⅔ size pan area 66D, one ½ size pan area 66B, and three ⅓ size pan areas 66A, 66C, 66E is shown in FIGS. 12A and 12B. Even within a given configuration of the pan frame 60, the exact position of each pan area in the compartment 16 (e.g., in the two rows) can vary and be set by the operator as desired. Moreover, in some configurations, the pan frame 60 may also form one or two excess areas (see FIG. 12A above pan area 66E, and FIG. 12B below pan area 66E). These excess areas are smaller than the ⅓ size pan area and are not sized and shaped to correspond to a standard size pan. Nevertheless, each excess area may still be able to receive one or more smaller (e.g., 1/9 size) pans if desired. Also, each excess area may serve as a useful location for a removable transfer shelf 84 (see FIG. 1) described in more detail below. As used herein, the term “standard pan area” refers to a full size pan area sized and shaped to receive a single full size pan, a ⅔ size pan area sized and shaped to receive a single ⅔ size pan, a ½ size pan area sized and shaped to receive a single ½ size pan, and/or a ⅓ size pan area sized and shaped to receive a single ⅓ size pan. The term “standard pan area” encompasses these standard sizes and is meant to exclude other areas (e.g., the excess area mentioned above) that do not correspond to one of these standard sizes, even though such other areas may still be able to receive a pan.

Referring to FIGS. 12A and 12B, the pan layout formed by the pan frame 60 is reversible. In particular, the orientation of the pan frame 60 relative to the well 14 is reversible. The pan frame 60 (and hold-down frame 62) can be rotated 180 degrees (see orientation of the pan frame in FIG. 12A versus FIG. 12B) to position the pan areas 66A-E, and therefore the pans, as desired. The pan frame 60 in FIGS. 12A and 12B is configured the same way, the only difference being that the orientation of the pan frame in FIG. 12B is rotated 180 degrees (about a vertical axis) relative to the orientation of the pan frame in FIG. 12A. It may also be possible to reverse the pan layout by moving the secondary supports 70 to different connection locations on the first support 68.

In one desirable pan layout, the pan frame 60 bounds a full size pan area in one row, two ⅓ size pan areas in the other row, and a ½ size pan area in the other row, between the two ⅓ size pan areas (e.g., this is a four pan area configuration). The full size pan area receives a full size pan containing the breading, one ⅓ size pan area receives a ⅓ size pan containing one type of food to be coated (e.g., chicken nuggets), the other ⅓ size pan area receives a ⅓ size pan containing another type of food to be coated (e.g., chicken filets), and the ½ size pan area receives a ½ size pan containing the batter. In one operation, the user takes a piece of food out of one of the ⅓ size pans, dips the piece of food in the batter contained in the ½ size pan, and then coats the piece of food in the breading contained in the full size pan.

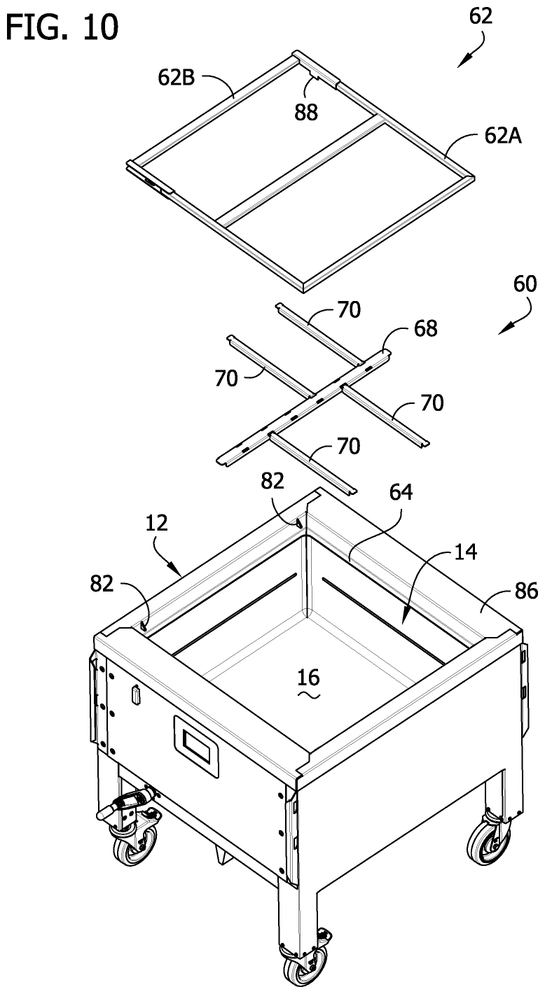

Referring to FIGS. 9 and 10, the hold-down frame 62 of the breading station 10 is configured to be positioned over the lips of the pans after the pans are inserted into the compartment 16 (e.g., positioned in their respective pan areas 66A-E). The hold-down frame prevents the pans from moving or floating upward in the compartment 16. This also ensures that the lower portions of each pan are in sufficient contact with the ice bath in the compartment 16 to refrigerate the food contained in the pans. The hold-down frame 62 includes a first frame section 62A and a second frame section 62B. The two frame sections 62A, 62B can slide inward and outward relative to one another so that the hold-down frame 62 can be attached to and removed from the housing 12 (e.g., well 14). The housing 12 (e.g., well 14) includes a plurality of retainers 82 disposed above the lip 64. In the illustrated embodiment, two retainers 82 are disposed on one side of the well 14 and two retainers are disposed on the other side of the well. The retainers 82 are fixed to the well 14. The retainers 82 engage the hold-down frame 62 to prevent the hold-down frame from moving upward or lifting, as a result of pans wanting to float, thereby preventing the pans from moving upward and floating in the ice bath. In operation, first the pan frame 60 is placed in the compartment 16 (e.g., on the lip 64 of the well 14) and then the pans are inserted into the pan frame (e.g., in the pan areas 66A-E) until the lips of the pans rest on the pan frame, and then the hold-down frame 62 is positioned over the pans. To move the hold-down frame 62 past the retainers 82, the two frame sections 62A 62B are moved inward relative to one another (decreasing the side to side dimension of the hold-down frame). After the hold-down frame 62 is lower than the retainers 82 (e.g., generally horizontal and engages with the pans), the two frame sections 62A 62B are moved outward relative to one another (increase the side to side dimension of the hold-down frame). This positions the sides of the hold-down frame directly below the retainers 82 (e.g., between the retainers and the lips of the pans), such that the retainers will engage the hold-down frame if the hold down frame moves upward. Together, the two frame sections 62A, 62B form a perimeter frame that extends around the perimeter of the compartment and overlies the lip 64 of the well 14 and one of the frame sections has a center strut or brace that overlies the first support 68 when the hold-down frame 62 is positioned over the pan frame 62.

In the illustrated embodiment, the hold-down frame 62 includes one or more tabs or flanges 88 (broadly, pan retainers) extending downward from the perimeter frame of the hold-down frame. The tabs 88 are configured to inhibit the pans from moving (e.g., front to back or side to side) relative to the well 14 in the compartment 16. In the illustrated embodiment, the tabs 88 are arranged to inhibit the pans from moving front to back, although arranging one or more tabs to prevent side to side movement is also contemplated. Each tab 88 is arranged to extend into the compartment of a pan when the pan is received in the pan frame 60 and the hold-down frame 62 is positioned in the well 14. When the hold-down frame 62 is installed in the well 14, a sidewall of the pan is trapped between the tab 88 and an interior surface of the well 14 (the interior surface extending downward from the lip 64), thereby inhibiting the sidewall (and thus the pan) from moving in the compartment 16. This is particular beneficial for the pan holding the breading. Typically, a user must methodically and aggressively massage the piece of food in the breading to fully and adequately coat the piece of food. This can result in repeated movement of the pan within the pan frame as the pan frame will typically have a clearance of about ¼″ to about ½″ in order to permit the pan to be easily inserted into and removed from the pan. Due to this clearance and the massaging of the breading on the piece of food, the pan with the breading may repeatedly move back and forth (e.g., forward and rearward) and bang into the pan frame 60 and/or well 14. The repeated impacts from this movement can damage the pan and/or well over time. The tab 88 of the present disclosure sandwiches a front or rear wall of the pan between the tab and the interior surface of the well 14, thereby preventing the pan from moving back and forth within the pan frame 60 (and relative to the well) when the piece of food is being breaded. The hold-down frame 62 may include a tab 88 on a rear portion of the perimeter frame (FIG. 9), a tab on a front portion of the perimeter frame (not shown), and/or a tab on a side (left and/or right) portion of the perimeter frame. Other configurations are within the scope of the present disclosure.

Referring to FIG. 1, the breading station 10 may include a shelf 84. The shelf 84 may simply sit or rest on the housing 12 and/or the hold-down frame 62. The shelf 84 can be removed by simply picking up the shelf and positioned by simply placing the shelf on the housing 12 and/or hold-down frame 62. The shelf 84 has an upper surface for supporting any desired item, such as another food pan, a fry basket that receives pieces of food after they have been breaded, or anything else. The illustrated shelf 84 includes a body with a horizontally rearwardly extending wall that engages and rests on the upper surface 86 of the housing 12. The body also includes an insert portion at the lower end of the body for being positioned in the compartment 16. The insert portion of the body includes two recesses on either side, each recess being sized and shaped to receive a portion of the hold-down frame 62. Further, this arrangement prevents the shelf 84 from moving laterally with respect to the hold-down frame 62. Other configurations of the shelf are within the scope of the present disclosure.

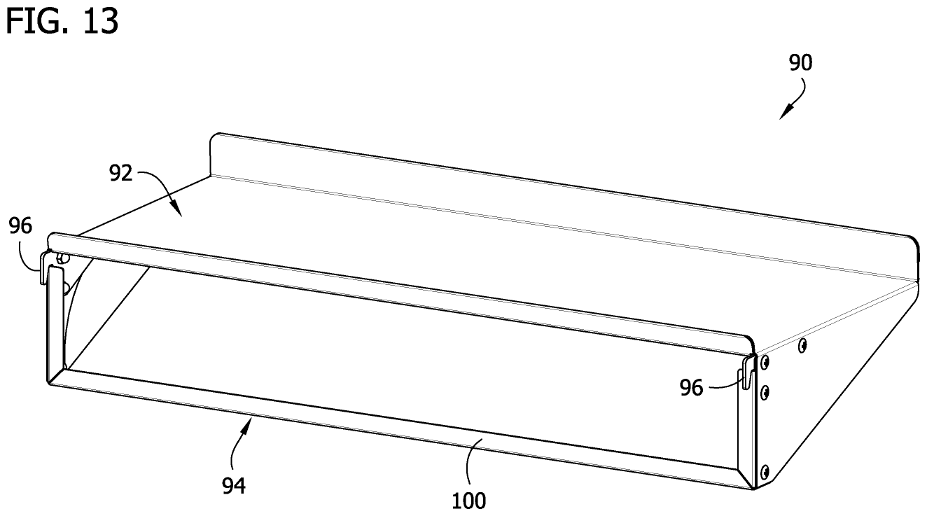

Referring to FIGS. 1, 2, and 13, the breading station 10 may include a side shelf 90. The side shelf 90 connects to the housing 12 (along a side thereof) to provide additional space for holding items, such as additional food pans, a fry basket, etc. The side shelf 90 includes a support platform 92 attached to support bracket 94. The support bracket 94 includes two hooks 96 for attaching the side shelf 90 to the housing 12. The housing 12 includes openings 98 on either side for receiving the hooks 96 of the side shelf 90. The housing 12 may include several sets of openings 98 on each side for attaching the side shelf 90 to the housing at different elevations. To attach the side shelf 90, the user inserts the hooks 96 through the pair of openings 98 of the housing 12 corresponding to the desired elevation of the side shelf and the desired side of the housing. To remove the side shelf 90, the user lifts the side shelf and moves the side shelf to withdraw the hooks 96 from the openings 98. The support bracket 94 includes a stiffener or brace 100 that engages a side (e.g., side panel) of the housing 12 to position the support platform in a generally horizontal position when the side shelf is mounted on the housing 12.

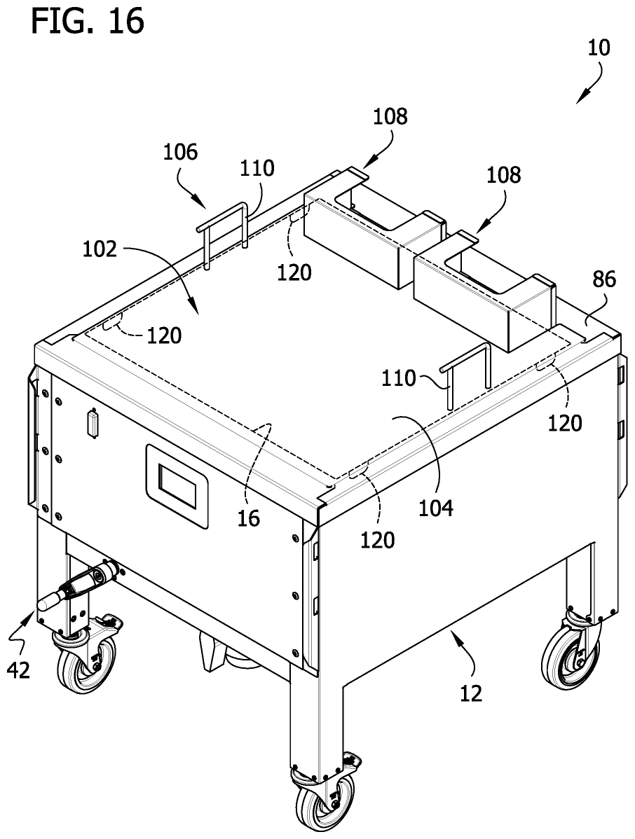

Referring to FIGS. 1-3 and 14-16, the breading station 10 can include a cover 102. For reasons that will become apparent, the cover 102 may also be referred to as an accessory stand. The cover 102 includes a support or wall 104 and a mount 106 attached to the wall. As illustrated, the cover 102 is arrangeable relative to the housing 12 in a first or erect position (FIGS. 1, 2, and 15) and a second or covering position (FIG. 16). In the erect position, the cover 102 is supported by the housing 12 in an erect configuration. The wall 104 is generally erect or vertically oriented. Further, the wall 104 is disposed rearward of the well 14, or more specifically, is disposed rearward of the housing 12. In the erect position, the wall 104 generally forms a rear wall of the breading station 10 that extends upward from the rear of the upper surface 86 of the housing 12. The wall 104 extends along and is engaged with the rear of the housing 12 (e.g., the rear exterior panel 48B). The mount 106 couples the cover 102 to the housing 12 in the erect position. In the illustrated embodiment, the mount 106 comprises two mounting brackets 110, although more (e.g., 2 or 4) or fewer (e.g., 1) mounting brackets are within the scope of the present disclosure. The mounting brackets 110 form handles and may be referred to as handles (e.g., first and second handles). The mounting brackets 110 are arranged to be grasped by one or more persons to move the cover between the erect and covering positions. In the erect position, the mounting brackets 110 are forward of the wall 104 so that they are easily accessible to be grasped. The mounting brackets 110 are spaced apart from one another, with one mounting bracket adjacent a left edge of the wall 104 and the other mounting bracket adjacent a right edge of the wall. In the illustrated embodiment, each mounting bracket 110 includes two base segments attached to and extending from the wall 104 (e.g., a forward surface thereof) at an orthogonal angle thereto and a cross segment extending between and interconnected to the base segments. The cross segment (e.g., a handle portion) is spaced from the wall 104 and may be the most convent portion of the mounting bracket 110 to grasp, although other portions of the mounting bracket can also be grasped. Other configurations of the mounting brackets are within the scope of the present disclosure. In the erect position, each mounting bracket 110 (broadly, the mount 106) engage the housing 12. In particular, the cover 102 is supported by the housing 12 in the erect position via the mounting brackets 110 resting on the housing. The two mounting brackets 110 (e.g., base segments thereof) rest on the upper surface 86 of the housing, thereby supporting the cover 102 on the housing 12.

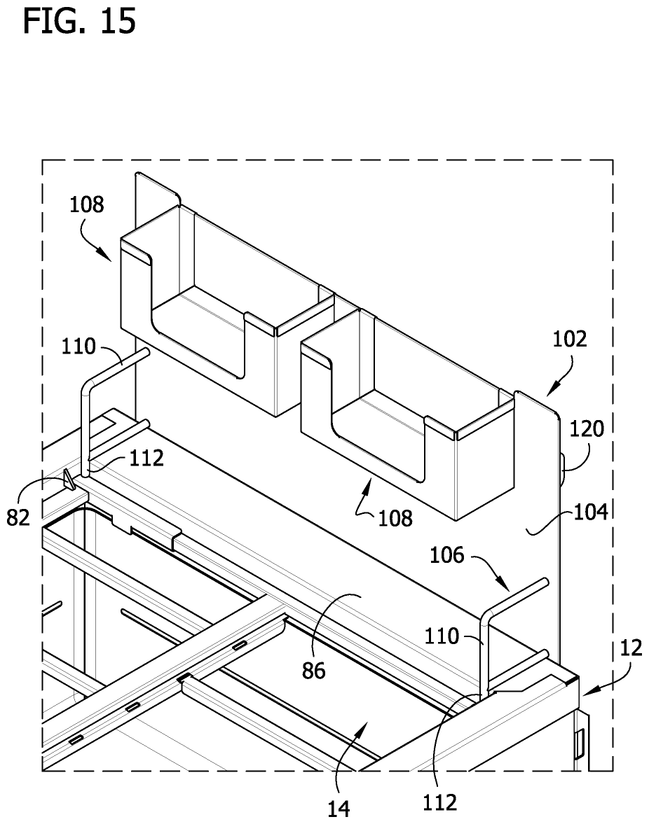

The mount 106 can include a retainer 112 for securing the cover 102 in the erect position. The retainer 112 is arranged to engage the housing 12 to secure the cover 102 to the housing in the erect position. As shown in FIG. 15, the retainer 112 is arranged to be disposed in the compartment 16 and engage the well 14 to inhibit the cover 102 from moving relative to the housing when the cover is in the erect position. In the illustrated embodiment, the mount 106 includes two retainers 112, one associated with each mounting bracket 110. Each retainer 112 is arranged to engage a rear interior surface of the well 14 bounding the compartment 16 to inhibit the cover 102 from moving rearward relative to the housing 12. Engagement between the wall 104 and the rear exterior panel 48B prevents the cover 102 from moving forward relative to the housing 12 in the erect position. Further, each retainer 112 is arranged to engage one of the sides (e.g., left side or right side) interior surface of the well 14 bounding the compartment 16 to inhibit the cover 102 from moving laterally relative to the housing 12. As such, each retainer 112 is disposed in one of the rear corners of the compartment 16, at the upper end (e.g., top opening) of the compartment, when the cover 102 is in the erect position. In the illustrated embodiment, each retainer 112 comprises an extension or projection of the cross segment of the mounting bracket 110, although other configurations are within the scope of the present disclosure.

The mount 106 is connectable to and disconnectable from the housing 12, in the erect position, without the user of tools. One method of positioning the cover 102 in the erect position comprises first positioning the wall 104 in a generally vertical orientation that is above and rearward of the housing 12, then moving the wall downward along the rear exterior panel 48B until the mount 106 (e.g., the mounting brackets 110) engages and rests on the upper surface 86 of the housing. To remove the cover 102 from the erect position, the process is generally reversed. The user or users grasps the mounting brackets 110 and lift the cover 102 upward. After the lower edge of the wall 104 clears the housing 12, the cover can be moved forward, such as to position the cover in the covering position.

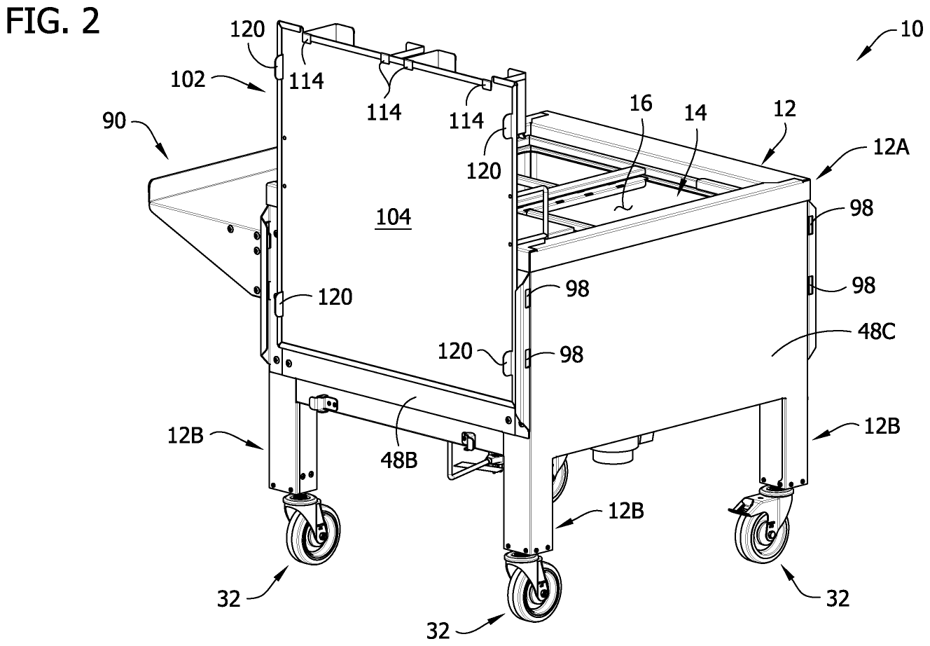

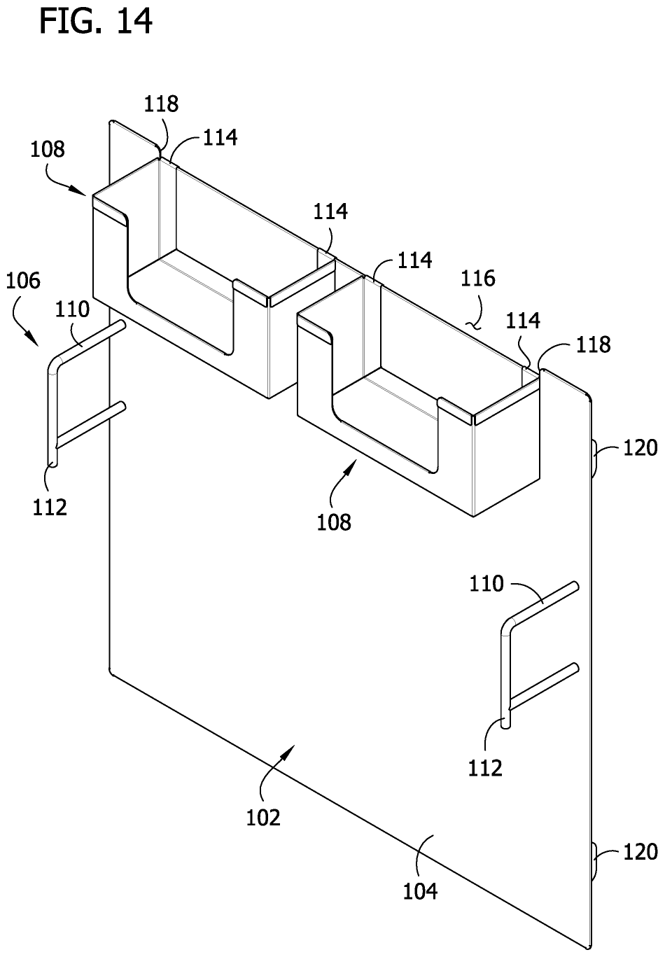

In the covering position (FIG. 16), the cover 102 covers the compartment 16. The cover 102 (specifically, the wall 104) is supported by the housing—e.g., rests on or lays over the upper surface 86 of the housing 12. The wall 104, desirably, completely closes or blocks the top opening of the compartment 16. In the illustrated embodiment, the wall 104 has a height greater than or equal to a width (measured front to back) of the top opening of the compartment 16 and the wall has a width greater than or equal to a length (measured side to side) of the top opening of the compartment. The cover 102 includes a plurality (broadly, one or more) locators 120 (FIGS. 2 and 14). The locators 120 (broadly, retainers) are used to position and retain the cover 102 in the covering position. Each locator 120 is attached to the wall 104. Specifically, each locator 120 extends rearward from a rearward surface of the wall 104. The locators 120 are arranged to extend into the compartment 16 (see FIG. 16) when the cover 102 is in the covering position to position the cover relative to the housing 12, specifically in a position where the wall 104 covers (e.g., is disposed over) the compartment 16. Each (broadly, at least one) locator 120 is arranged to engage one of the sides (e.g., left side or right side) interior surface of the well 14 bounding the compartment 16 to position the cover 102 and inhibit the cover 102 from moving laterally relative to the housing 12. Further, each (broadly, at least one) locator 120 is arrange to engage the well 14 to position the cover 102 and inhibit the cover from moving forward or rearward relative to the housing 12. Two locators 120 can be arranged to engage either a front interior surface of the well bounding the compartment 16 or the front two retainers 82 of the well 14 to inhibit forward movement and the other two locators can be arranged to engage ether the rear interior surface of the well or the rear two retainers 82 of the well to inhibit rearward movement. Other configurations of the locator are within the scope of the present disclosure.

The breading station 10 may include one or more accessory shelves or holders 108 that are supported by the cover 102. The accessory shelves 108 can be used to support different types of accessories, such as gloves (e.g., a box containing gloves). The accessory shelves 108 are supported by the cover 102 at an elevation above the compartment 16 (broadly, the housing 12) when the cover is in the erect position (FIG. 15). In the illustrated embodiment, each accessory shelf 108 includes two hooks 114 (FIG. 2) for removably connecting the accessory shelf to the wall 104 of the cover 102. Each hook 114 hooks over the upper edge margin (e.g., an upper edge) of the wall 104. The upper edge margin of the wall 104 includes a recess 116. The recess 116 is sized and shaped to receive the hooks 114 of the two accessory shelves 108. The recess 116 is bounded on the left and right by left and right edges 118. These edges 118 (broadly, retainers) inhibit the accessory shelves 108 from moving laterally relative to the cover 102 (e.g., inhibit the accessory shelves from inadvertently sliding off the wall 104). Other ways of coupling the accessory shelves to the cover, such as by fasteners or welding, are within the scope of the present disclosure. In the illustrated embodiment, the accessory shelves 108 are shown still attached to the cover 102 when the cover is in the covering position. It is understood that the accessory shelves 108 may be removed from the cover 102 before the cover 102 is moved to the covering position or when the cover is in the covering position.

Having described the disclosure in detail, it will be apparent that modifications and variations are possible without departing from the scope of the disclosure defined in the appended claims. For example, where specific dimensions are given, it is understood these dimensions are illustrative and other dimensions are within the scope of the present disclosure.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained. As various changes could be made in the above products and methods without departing from the scope of the disclosure, it is intended that all matter contained in the above description shall be interpreted as illustrative and not in a limiting sense.

### OTHER STATEMENTS OF THE DISCLOSURE

The following are statements of example embodiments described in the present disclosure. Although some of the following statements are not currently presented as claims, the statements are believed to be patentable and may subsequently be presented as claims. Associated methods corresponding to the statements or apparatus or systems below, are also believed to be patentable and may subsequently be presented as claims. It is understood that the following statements may refer to and be supported by one, more than one or all of the embodiments described above.

A1. A breading station comprising:
a housing including a well defining a cooling compartment sized and shaped to receive a plurality of pans; and
a pan frame configured to be supported by the housing, the pan frame bounding a plurality of pan receiving areas for receiving the plurality of pans, the pan frame arranged to suspend the plurality of pans in the cooling compartment when the pan frame is supported by the housing and the plurality of pans are received in the plurality of pan receiving areas, the pan frame being adjustable to change a dimension of at least one of the pan receiving areas to size said one pan area for receiving different pan sizes.

A2. The statement of A1, wherein said at least one pan receiving area is a first pan receiving area, the pan frame includes a first support and a second support, the second support bounding the first pan receiving area and a second pan receiving area of the plurality of the pan receiving areas, the second support being movable relative to the first support to change the dimension of the first pan receiving area and a dimension of the second pan receiving area.

A3. The statement of A2, wherein the second support is removably connectable to the first support at a first location and a second location different than the first location to change the dimensions of the first and second pan receiving areas.

A4. The statement of A3, wherein the second support is connectable to and disconnectable from the first support without the use of tools.

A5. The statement of A4, wherein the second support includes a manually operable connector configured to connect the second support to the first support.

A6. The statement of A5, wherein the connector comprises a hook, and wherein the first support includes a first opening at the first location that is sized and shaped to receive the hook and a second opening at the second location that is sized and shaped to receive the hook.

A7. The statement of A2, wherein the pan frame bounds a third pan receiving area of the plurality of the pan areas, the third pan receiving area sized and shaped to receive a third pan of the plurality of pans, the pan frame including a third support bounding the third pan receiving area, the third support being movable relative to the first support to change a dimension of the third pan receiving area.

A8. The statement of A7, wherein the pan frame bounds a fourth pan receiving area of the plurality of pan receiving areas, the fourth pan receiving area sized and shaped to receive a fourth pan of the plurality of pans, the pan frame including a fourth support bounding the fourth pan receiving area, the fourth support being movable relative to the first support to change a dimension of the fourth pan receiving area.

A9. The statement of A1, wherein said at least one pan receiving area is a first pan receiving area, wherein the plurality of pan receiving areas includes a second pan receiving area, a third pan receiving area, and a fourth pan receiving area, the first pan receiving area being sized and shaped to receive a ⅓ size pan, the second pan receiving area being sized and shaped to receive a ½ size pan, the third pan receiving area being sized and shaped to receive a ⅓ size pan, and the fourth pan receiving area sized and shaped to receive a full size pan.

A10. The statement of A1, wherein the pan frame is configurable in a first configuration where the plurality of pan receiving areas bounded by the frame includes a total of no more than three pan receiving areas, a second configuration where the plurality of pan receiving areas bounded by the frame includes a total of no more than four pan receiving areas, and a third configuration where the plurality of pan receiving areas bounded by the frame includes a total of no more than five pan receiving areas.

A11. The statement of A10,
wherein the three pan receiving areas of the first configuration include:
   one pan receiving area sized and shaped to receive a full size pan, one pan receiving area sized and shaped to receive a ½ size pan, and one pan receiving area sized and shaped to receive a ⅔ size pan; or
   one pan receiving area sized and shaped to receive a full size pan and two pan receiving areas sized and shaped to receive a ½ size pan;
wherein the four pan receiving areas of the second configuration include:
   one pan receiving area sized and shaped to receive a full size pan, one pan receiving area sized and shaped to receive a ½ size pan, and two pan receiving areas sized and shaped to receive a ⅓ size pan; or
   one pan receiving area sized and shaped to receive a full size pan and three pan receiving areas sized and shaped to receive a ⅓ size pan; or
   four pan receiving areas sized and shaped to receive a ½ size pan; or
   two pan receiving areas sized and shaped to receive a ½ size pan and two pan receiving areas sized and shaped to receive a ⅔ size pan; or
   two pan receiving areas sized and shaped to receive a ⅓ size pan and two pan receiving areas sized and shaped to receive a ⅔ size pan; and
wherein the five pan receiving areas of the third configuration include:
   one pan receiving area sized and shaped to receive a ⅔ size pan, two pan receiving areas sized and shaped to receive a ½ size pan, and two pan receiving areas sized and shaped to receive a ⅓ size pan; or
   one pan receiving area sized and shaped to receive a ⅔ size pan, one pan receiving area sized and shaped to receive a ½ size pan, and three pan receiving areas sized and shaped to receive a ⅓ size pan; or
   two pan receiving areas sized and shaped to receive a ½ size pan, and three pan receiving areas sized and shaped to receive a ⅓ size pan; or
   one pan receiving area sized and shaped to receive a ⅔ size pan and four pan receiving areas sized and shaped to receive a ⅓ size pan.

B1. A breading station comprising:
a housing including a well defining a cooling compartment sized and shaped to receive one or more pans;
a cover including a wall and first and second handles attached to the wall, the cover arrangeable relative to the housing in a first position in which the cover is supported by the housing and the wall is upstanding, and a second position in which the cover is supported by the housing and the wall covers the cooling compartment, the first and second handles being spaced apart from one another, the first and second handles being arranged to be grasped by one or more persons to move the cover between the first and second positions.

B2. The statement of B1, wherein the first and second handles engage the housing when the cover is in the first position.

B3. The statement of B1, wherein the cover is supported by the housing in the first position via the first and second handle resting on the housing.

B4. The statement of B3, wherein the housing includes an upper surface and the cooling compartment extends downward from the upper surface of the housing, the first and second handles being arranged to rest on the upper surface of the housing when the cover is in the first position.

B5. The statement of B1, wherein the cover includes one or more locators attached to the wall, the one or more locators arranged to extend into the cooling compartment when the cover is in the second position to position the cover relative to the housing.

B6. The statement of B1, further comprising an accessory shelf configured to be supported by the cover at an elevation above the cooling compartment when the cover is in the first position.

B7. The statement of B6, wherein the accessory shelf includes a hook configured to removably connect to the wall of the cover, the wall including an edge arranged to inhibit the accessory shelf from moving laterally relative to the cover.

C1. A breading station comprising:
a housing including a well defining a cooling compartment sized and shaped to receive one or more pans;
a cover including a wall and a mount attached to the wall, the cover arrangeable relative to the housing in a first position in which the mount couples the cover to the housing and the wall is upstanding and a second position in which the cover is supported by the housing and the wall covers the cooling compartment.

C2. The statement of C1, wherein the housing includes an upper surface and the cooling compartment extends downward from the upper surface of the housing, the mount being arranged to rest on the upper surface of the housing when the cover is in the first position.

C3. The statement of C2, wherein the mount includes a retainer arranged to be disposed in the cooling compartment and to engage the well to inhibit the cover from moving relative to the housing when the cover is in the first position.

C4. The statement of C1, wherein the mount is connectable to and disconnectable from the housing without the use of tools.

C5. The statement of C1, wherein the mount comprises a first mounting bracket and a second mounting bracket configured to couple the cover to the housing when the cover is in the first position.

C6. The statement of C5, wherein the housing includes an upper surface and the cooling compartment extends downward from the upper surface of the housing, the first and second mounting brackets each being arranged to rest on the upper surface of the housing when the cover is in the first position.

C7. The statement of C5, wherein the first mounting bracket forms a first handle and the second mounting bracket forms a second handle, the first and second handles being arranged to be grasped by one or more persons to move the cover between the first and second positions.

C8. The statement of C1, wherein the cover includes a plurality of locators attached to the wall, the plurality of locators arranged to extend into the ice bath compartment when the cover is in the second position and to engage the well to inhibit the cover from moving relative to the housing when the cover is in the second position.

What is claimed is:

1. A breading station comprising:
a housing including a well defining a cooling compartment sized and shaped to receive one or more pans, the cooling compartment having an opening sized and shaped to receive the one or more pans; and
a hydraulic lift system arranged to raise and lower the well relative to a surface on which the breading station rests, the hydraulic lift system including a hydraulic pump system, a hydraulic actuator, and a hydraulic line, the hydraulic pump system being in fluid connection with the hydraulic actuator at least in part via the hydraulic line so that operation of the hydraulic pump system actuates the hydraulic actuator to raise and lower the well, the hydraulic pump system and the hydraulic actuator being connected to the housing, the hydraulic pump system and the hydraulic actuator being disconnectable from the housing and removable from the housing without having to break the fluid connection between the hydraulic pump system and the hydraulic actuator.

2. The breading station of claim 1, wherein the housing includes a first opening, the hydraulic line extending through the first opening, the first opening being sized and shaped to enable the hydraulic actuator to pass through the first opening to permit the hydraulic actuator to be removed from the housing.

3. The breading station of claim 2, wherein the housing includes a removable panel arranged to permit access to the first opening and the hydraulic actuator.

4. The breading station of claim 2, wherein the housing includes a second opening, the hydraulic line extending through the second opening, the second opening being sized and shaped to enable the hydraulic actuator to pass through the second opening to permit the hydraulic actuator to be removed from the housing.

5. The breading station of claim 1, further comprising a foot arranged to engage the surface to support the breading station on the surface, the hydraulic actuator being configured such that operation of the hydraulic pump system actuates the hydraulic actuator to change a distance between the foot and the well.

6. The breading station of claim 1, wherein the hydraulic actuator is a first hydraulic actuator and the hydraulic line is a first hydraulic line, wherein the hydraulic lift system includes a second hydraulic line and a second hydraulic actuator in fluid connection with the hydraulic pump system at least in part via the second hydraulic line so that operation of the hydraulic pump system actuates the second hydraulic actuator to raise and lower the well, the second hydraulic actuator being connected to the housing, the second hydraulic actuator being disconnectable and removable from the housing without having to break the fluid connection between the hydraulic pump system and the second hydraulic actuator.

7. The breading station of claim 6, wherein the housing includes a first leg and a second leg, the first hydraulic actuator being at least partially disposed in the first leg and the second hydraulic actuator being at least partially disposed in the second leg.

8. The breading station of claim 6, wherein the housing includes a first opening and a second opening, the first hydraulic line extending through the first opening and the second hydraulic line extending through the second opening, the first opening being sized and shaped to enable the first hydraulic actuator to pass through the first opening to permit the first hydraulic actuator to be removed from the housing, and the second opening being sized and shaped to enable the second hydraulic actuator to pass through the second opening to permit the second hydraulic actuator to be removed from the housing.

9. A breading station comprising:
a housing including a well defining a cooling compartment sized and shaped to receive one or more pans, the cooling compartment having an opening sized and shaped to receive the one or more pans, the housing including a frame supporting the well and an exterior panel removably connected to the frame; and
a hydraulic lift system arranged to raise and lower the well relative to a surface on which the breading station rests, the hydraulic lift system including a hydraulic pump system and a hydraulic linear actuator having a fluid connection with the hydraulic pump system so that operation of the hydraulic pump system actuates the hydraulic actuator to raise and lower the well;
wherein the exterior panel is arranged to block access to the hydraulic actuator when the exterior panel is connected to the frame and permit access to the hydraulic actuator when the exterior panel is disconnected from the frame.

10. The breading station of claim 9, wherein the exterior panel is removably connected to the frame with one or more fasteners.

11. The breading station of claim 9, wherein the housing includes a leg and the hydraulic actuator is at least partially disposed in the leg, the exterior panel forming at least a portion of the leg.

12. The breading station of claim 9, wherein the hydraulic lift system includes a hydraulic line at least partially forming the fluid connection between the hydraulic pump system and the hydraulic actuator, and wherein the housing includes an opening, the hydraulic line extending through the opening, the opening being sized and shaped to enable the hydraulic actuator to pass through the opening, the exterior panel being arranged to block access to the opening when the exterior panel is connected to the frame and to permit access to the opening when the exterior panel is disconnected from the frame.

13. The breading station of claim 9, wherein the exterior panel is a first exterior panel and the hydraulic actuator is a first hydraulic actuator, the housing including a second exterior panel removably connected to the frame, the hydraulic lift system including a second hydraulic actuator, the second actuator having a fluid connection with the hydraulic pump system so that operation of the hydraulic pump system actuates the second hydraulic linear actuator to raise and lower the well, the second exterior panel being arranged to block access to the second hydraulic actuator when the second exterior panel is connected to the frame and to permit access to the second hydraulic actuator when the second exterior panel is disconnected from the frame.

14. The breading station of claim 13, wherein the first and second exterior panels are disposed on opposite first and second sides of the housing.

15. The breading station of claim 14, wherein the housing includes a third exterior panel removably connected to the frame.

16. The breading station of claim 15, wherein the hydraulic lift system includes a first hydraulic line fluidly connecting the hydraulic pump system and the first hydraulic actuator to one another and a second hydraulic line fluidly connecting the hydraulic pump system and the second hydraulic actuator to one another, and wherein the housing includes an opening, the first and second hydraulic lines extending through the opening, the opening being sized and shaped to enable the first hydraulic actuator to pass through the opening and being sized and shaped to enable the second hydraulic actuator to pass through the opening, the third exterior panel being arranged to block access to the opening when the third exterior panel is connected to the frame and to permit access to the opening when the exterior panel is disconnected from the frame.

17. The breading station of claim 16, wherein the first and second sides are left and right sides, and wherein the third exterior panel is disposed on a front or a rear of the housing.

18. A breading station comprising:
a housing including a well defining an cooling compartment sized and shaped to receive a plurality of pans; and
a pan frame configured to be supported by the housing, the pan frame bounding a plurality of pan receiving areas for receiving the plurality of pans, the pan frame arranged to suspend the plurality of pans in the cooling compartment when the pan frame is supported by the housing and the plurality of pans are received in the plurality of pan receiving areas, the pan frame being adjustable to change a dimension of at least one of the pan receiving areas to size said at least one pan receiving area for receiving different pan sizes.

19. The bearding station of claim 18, wherein said at least one of the pan receiving areas is a first pan receiving area, the pan frame including a first support and a second support, the second support bounding the first pan receiving area and a second pan receiving area of the plurality of pan receiving areas, the second support being movable relative to the first support to change the dimension of the first pan receiving area and a dimension of the second pan receiving area.

20. The breading station of claim 19, wherein the second support is removably connectable to the first support at a first location and a second location different than the first location to change the dimensions of the first and second pan receiving areas.
